(19) United States
(12) Patent Application Publication
(10) Pub. No.: US 2011/0111279 A1
(43) Pub. Date: May 12, 2011

(54) BINDER-FREE NANOCOMPOSITE MATERIAL AND METHOD OF MANUFACTURE

(75) Inventors: Jesse Smithyman, Tallahassee, FL (US); Zhiyong Liang, Tallahassee, FL (US); Jim P. Zheng, Tallahassee, FL (US); Ben Wang, Tallahassee, FL (US); Chun Zhang, Tallahassee, FL (US)

(73) Assignee: Florida State University Research Foundation Inc., Tallahassee, FL (US)

(21) Appl. No.: 12/942,863

(22) Filed: Nov. 9, 2010

Related U.S. Application Data
(60) Provisional application No. 61/259,599, filed on Nov. 9, 2009.

(51) Int. Cl. H01M 4/13; B29C 39/00; B32B 5/02; B32B 5/00; B32B 5/16; H01M 2/16; D21H 17/63; B82Y 30/00

(52) U.S. Cl. 429/122; 264/299; 264/255; 428/221; 428/220; 428/338; 162/181.9; 977/750; 977/752

(57) ABSTRACT

This disclosure provides improved composite materials and methods for making the composite materials. Specifically, binder-free composite materials have been developed that have a network of CNTs in which one or more types of particles or fibers is embedded. The composite materials may be made by filtering suspensions containing carbon nanotubes, particles or fibers of interest, or both carbon nanotubes and particles or fibers of interest. The particles may be silicon particles, activated carbon particles, particles of a lithium compound, any other particles, or a combination thereof. The composite materials have a large number of applications, including electrical devices.

### CROSS-REFERENCE TO RELATED APPLICATIONS

Priority is claimed to U.S. Provisional Application No. 61/259,599, filed Nov. 9, 2009. The provisional application is incorporated herein by reference.

### FIELD OF THE INVENTION

This disclosure relates generally to composite materials including carbon nanotubes, and more particularly to carbon nanotube networks as the host for one or more types of particles.

### BACKGROUND

It is known to make electrode or membrane materials that include carbon nanotubes (CNTs), particles, or mixtures of these materials. There are a limited number of options, however, for assembling the CNTs and particles into a usable structure. Conventional materials either are created on a substrate (i.e., they are not free-standing) and/or use an adhesive binder to form a useable sheet material. Although the use of polymer binders is very common, binders can significantly limit the resulting material's useful properties. For example, binders may cause potential performance limitations within electrical energy storage devices.

Nevertheless, many commercial supercapacitor electrodes are made of activated carbon (aC) particles and about 1-25% polymeric binder. U.S. Pat. No. 7,295,423 to Mitchell et al. discloses a manufacturing process for creating carbon based electrodes. The process utilizes direct mixing of activated and conducting carbons with polymer binders. The use of a binder, however, is undesirable because it reduces available surfaces and severely decreases the electrical conductivity of the material due to its high electrical resistance. The binder may also lead to device failure due to structure deterioration, because it could be more susceptible to degradation through chemical, thermal, and other means.

When polymer binders are used in the fabrication of electrodes, the inactive, insulating, and adhesive properties of polymers may lead to significant disadvantages. The adhesive properties of polymer binders necessitate that portions of the particles' surfaces are covered with the polymer binder, thereby reducing the accessible surface area of the particles. This reduction of the accessible surface area of the particles, in turn, limits the number of interactions available between the electrolyte ions and the surfaces of the particles. Energy storage mechanisms initiate with these interactions, and reducing them may contribute to a reduction in the maximum theoretical specific energy achievable when the materials are used as energy storage devices. For example, it has been reported that the surface area of aC powders may be reduced by more than 25% after electrode fabrication. See Gamby, J. et al. J. POWER SOURCES, 101, 2001, 109-116.

Other disadvantages are caused by the insulating properties of polymer binders. Any added resistance in a device which has the primary functions of receiving and distributing electrical current is undesirable due to the inefficiencies created by resistive losses. The high resistance from the insulating binder decreases the efficiency of electron transfer, and the lost electrical energy is converted into heat within the electrode, which may cause devices to malfunction.

The polymer binder may also contribute further to heat generation due to exothermic reactions with various components within the device. For example, polyvinylidene fluoride (PVDF) is a thermoplastic fluoropolymer which is commonly used as a binder in electrochemical capacitor and battery electrodes. Researchers have reported on the possibility of PVDF reacting with carbons, lithiated carbons, and lithium. See Maleki, J. ELECTROCHEM. SOC., 147, 2000, 4470-4475; and Yang, H. et al. J. ELECTROCHEM. SOC., 152, 2005, A73-A79. These reactions can be highly exothermic. It has been reported that reactions with metallic lithium can produce several kilojoules of energy per gram of PVDF. Thermal runaway is a significant problem with some electrical energy storage systems, particularly in lithium-based batteries. Safety systems to prevent dangerous occurrences due to this thermal runaway can be very costly. Minimizing any forms of heat generation would be beneficial for both safety and cost considerations. These factors are important for the long-term success of emerging markets such as hybrid electric vehicles (HEV) and plug-in electric vehicles (PEV) which rely on these devices. See Beguin, F. et al. Carbons for Electrochemical Energy Storage and Conversion Systems, Boca Raton: CRC Press, 2009.

The cycle life is also an important consideration in the economical evaluations of electrochemical capacitors (ECs), batteries, and systems containing these devices. For example, a battery that can last twice as long as another will be more valuable. Gallay and Gualous list the weakening of the adhesion between the electrode and current collector (due to time and temperature) as one of the three main failure modes for electrochemical capacitors. See Id. This weakening is due to the susceptibility of polymers to chemical, thermal, and mechanical degradation. It is imperative that the active material must be accessible to electrons from the external circuit; otherwise the electronically un-accessible mass cannot contribute to the energy storage. In addition to the decrease of specific energy achievable, the weakening adhesion can cause a decrease in the specific power of a device due to an increased equivalent series resistance (ESR).

Major drawbacks associated with polymer binder electrodes come not only directly from the polymer's properties, but also indirectly from the components which are used to compensate for these properties. One example of such a component is a metallic current collector, which is added due to the comparatively high resistance of the binder based electrode. The metallic current collectors in batteries and electrochemical capacitors introduce a significant amount of inactive weight. Current collector mass densities can be upwards of 8× the density of the electrode material for copper. These high densities can severely reduce the amount of specific energy which is achievable within these cells since they add mass but do not participate in the energy storage. Landi et al. produced theoretical calculations showing that for a cell with a high capacity anode without the copper current collector, an 80% increase in specific energy density could be achieved over conventional lithium-ion (Li-ion) batteries. See Landi, B. J. et al. J. MAT. RES., 25, 2010, 1636-1644.

The presence of the metallic elements within the electrochemical cell may also limit the window of operation voltage. For example, due to copper's oxidation potential around 2.5V, Li-ion cells are prevented from discharging to such a potential. See Id. With the removal of copper from the system, the depth of discharge could be increased which would create enhanced opportunities for prolonged battery storage. See Hossain, S. et al. “Carbon-carbon composite as anodes for lithium-ion battery systems,” J. POWER SOURCES, 96, 2001.

The polymer binder electrode also has shown a lack of ability to provide room for particles which undergo large volume change during charging and discharging. The large volume expansion of certain particles is associated with large specific capacities. For example, silicon has the highest theoretical capacity of any known material for anodes of Li-ion batteries. However, poor cycle life due to particle pulverization and loss of electrical contact limits the amount of charge-discharge cycles for which this high capacity is obtainable. A possible cause for the particle pulverization is large amounts of induced stress and strain because the particles have no room to expand within the electrode.

Many applications such as electric vehicles, portable electronics, and renewable energy generation rely on the storage of electrical energy, particularly through the use of batteries. For example, the energy density of current batteries limits the widespread adoption of electrical vehicles. The costs associated with using the large number of batteries required to store the desired amount of energy for the vehicle is much too high. The development of batteries with higher energy densities can provide benefits to many applications, such as affordable electric vehicles.

Li-ion batteries are among the most widely used secondary (rechargeable) batteries. Although the energy density of Li-ion batteries is high compared with other battery chemistries, it is highly desirable to further increase the energy density. One such method to increase the energy density is to use active electrode materials which have a higher Li-ion storage capacity. Silicon is an attractive material for Li-ion battery anodes because it has the highest known theoretical capacity for lithium ions (around 4000 mAh/g). This is significantly higher than the capacity of graphitic carbons which are the current material used in commercial Li-ion batteries. The theoretical capacity for LiC₆ is only 372 mAh/g.

Previous reports have discussed supporting nanoparticles by networks of single-walled carbon nanotubes (SWNTs). See Raffaelle, R. P. et al. U.S. Patent Publication No. 2008/0254362. Other reports describe combining carbon nanotubes (CNTs) with electrolytes to form a paste. See Gruner, G. et al. U.S. Patent Publication No. 2010/0178543. However, when the particle size decreases below several hundred nanometers, ensuring electrical connection with the particles becomes challenging in this type of composite system. Nanoparticles have sizes which are comparable to the inter-tube or inter-bundle spacing within CNT networks. Since the size of the particle is similar to the size of void spaces within the CNT networks, the nanoparticles easily move around and lose contact with the network. An unstable and unreliable electrical connection may therefore exist between the active nanoparticles and the CNTs, especially as the nanoparticles' size approaches the pore size of the material.

Nanoparticles also have a tendency to agglomerate together due to strong van der Waals attractions. Agglomerations or particle clusters will further hinder the transport of electrons to the particles. The particles within the cluster centers will not be able to make contact with the CNTs because they are shielded by other particles surrounding them. If the CNTs are not contacting the nanoparticles, electron transport during charging and discharging will be hindered greatly, and possibly prevented all together for some of the nanoparticles. Nanoparticles which are not accessible to electrons from the external circuit are not able to participate in the energy storage process.

Therefore, it would be desirable to provide improved composite materials that include functional particles, such as silicon particles, particles of lithium compounds, or aC particles. Desirably, the composite material would have increased surface area and electrical conductivity, and/or low mass density. In addition, it would be desirable to provide composite materials, for example for use as electrodes, in energy storage devices, and the like, with the chemical or electrochemical properties of carbon.

### BRIEF SUMMARY

Improved composite materials and methods for making the composite materials have been developed. In one aspect, this disclosure relates to binder-free composite materials comprising a network of CNTs in which one or more types of particles or fibers is embedded. In another aspect, this disclosure relates to a binder-free, free-standing composite material in the form of a sheet or membrane, which comprises a network of carbon nanotubes in which one or more types of particles or fibers is embedded. In yet another aspect, this disclosure relates to a method for making a binder-free composite material comprising a network of CNTs in which one or more types of particles or fibers is embedded. The particles may be silicon particles, aC particles, particles of a lithium compound, any other particles, or a combination thereof.

In another aspect, this disclosure relates to composite materials which may be used in a wide variety of electrical devices. The composite materials described herein may be used as or in a capacitor, supercapacitor, battery/capacitor, fuel cell, or an electrode in a lithium-ion battery. Other uses for the composite materials are described herein.

### BRIEF DESCRIPTION OF THE DRAWINGS

FIG. 1 is a schematic of a network of CNTs supporting a multitude of particles—the CNTs create a high conductive path between the particles.

FIG. 2 depicts a cross-section of the Flocell apparatus.

FIG. 3 is a schematic of a layer-by-layer filtration process scheme.

FIG. 4 is a cross-section scanning electron microscope (SEM) image of a composite material of Si:SWNT (80:20) with several of the silicon particles circled.

FIG. 5 is a cross-section SEM image of a composite material of Si:SWNT (80:20) that shows SWNT networks surrounding the silicon particle with jagged surface features.

FIG. 6 depicts the charge-discharge profiles for a lithium-ion cell using the composite material of Si:SWNT (80:20) as an electrode vs. lithium metal.

FIG. 7 depicts the charge and discharge capacities of the first 5 cycles for a lithium-ion battery with the composite material of Si:SWNT (80:20) as an electrode vs. lithium metal.

FIG. 8 is a cross-section SEM image of a composite material of Si:MWNT (80:20).

FIG. 9 depicts the charge-discharge profiles for a lithium-ion cell using the composite material of Si:MWNT (80:20) as an electrode vs. lithium metal.

FIG. 10 is a cross-section SEM image showing the engineered microstructure of a Si:SWNT (80:20) composite material created by the layer-by-layer filtration scheme.

FIG. 11 is an illustration of the highly flexible aC-CNT electrode wrapped around a rod with a half-inch diameter.

FIG. 12 is a cross-section SEM image of an aC:SWNT (50:50) composite material showing the uniform distribution of aC particles within the SWNT matrix.

FIG. 13 is an SEM image of an aC:SWNT (50:50) composite material showing two types of interactions between the CNTs and aC particles.

FIG. 14 shows the electrical conductivity as a function of aC weight fraction and based on the conductivity of pure SWNT networks.

FIG. 15 shows a comparison of the measured BET surface areas for samples with varying aC weight fractions and the predicated surface area using the rule-of-mixtures approach in formula (1).

FIG. 16 shows the pore size distributions (PSDs) of various samples using the BJH model derived from the adsorption branch of the nitrogen adsorption isotherm.

FIG. 17 shows galvanostatic cycling of symmetrical electrochemical capacitor with aC:SWNT (50:50).

FIG. 18 shows half-cell galvanostatic cycling at 10 A/g in 1M KOH with platinum foil counter electrode and saturated calomel electrode (SCE) reference.

FIG. 19 is a cross-section SEM of LiCoO₂:MWNT (95:5) electrode.

FIG. 20 is a low-magnification top-view SEM image showing uniform distribution of aC particles in CNT network.

FIG. 20 is high magnification image of an aC particle partially pulling out of the CNT matrix.

FIG. 22 is an SEM image of the of the cross-section of a aC:MWNT (67:33) composite electrode.

### DETAILED DESCRIPTION

A variety of different free-standing, binder-free sheets may be provided by embedding various materials, such as micro- and nano-sized particles of different compositions, within a highly conductive CNT network. In a preferred embodiment of these nanocomposite materials, the carbon nanotubes themselves are used as a matrix to support other functional materials, including particles or fibers.

As used herein, the terms “nanocomposite” and “composite material” are used interchangeably. Also, as used herein, a composite material that is “free of polymeric binder” is one containing no polymeric binder or one in which the amount of binder present is negligible, e.g., insufficient to bind the material's components together over any substantial portion of the composite material's structure.

### The Composite Material

In one embodiment, a free-standing sheet- or membrane-like material composed of carbon nanotubes (CNTs) and at least one type of particles is provided without the use of any adhesive or polymer binders. The particles are embedded in a network, or matrix, of SWNTs, multiple-walled carbon nanotubes (MWNTs), carbon fiber material, or any combination thereof.

The term “CNT,” as used herein, refers to SWNTs, MWNTs, carbon nanofibers, or any combination thereof.

The thicknesses of the composites may range from a few microns to several hundred microns. In some embodiments, the composite is from about 10 μm to about 500 μm thick. In one embodiment, the composite is from about 30 μm to about 500 μm thick. In another embodiment, the composite is from about 50 μm to about 500 μm thick. In yet another embodiment, the composite is from about 70 μm to about 500 μm thick. In a further embodiment, the composite is from about 90 μm to about 500 μm thick. In another further embodiment, the composite is from about 110 μm to about 500 μm thick. In yet another further embodiment, the composite is from about 130 μm to about 500 μm thick. The thickness of the composite is application specific. In some instances, composite materials that serve as electrochemical capacitors should be as thick as possible in order to provide more overall surface for ion adsorption to occur. In other instances, the thickness of a particular electrode will be determined by the desired ratio of active material between the two electrodes.

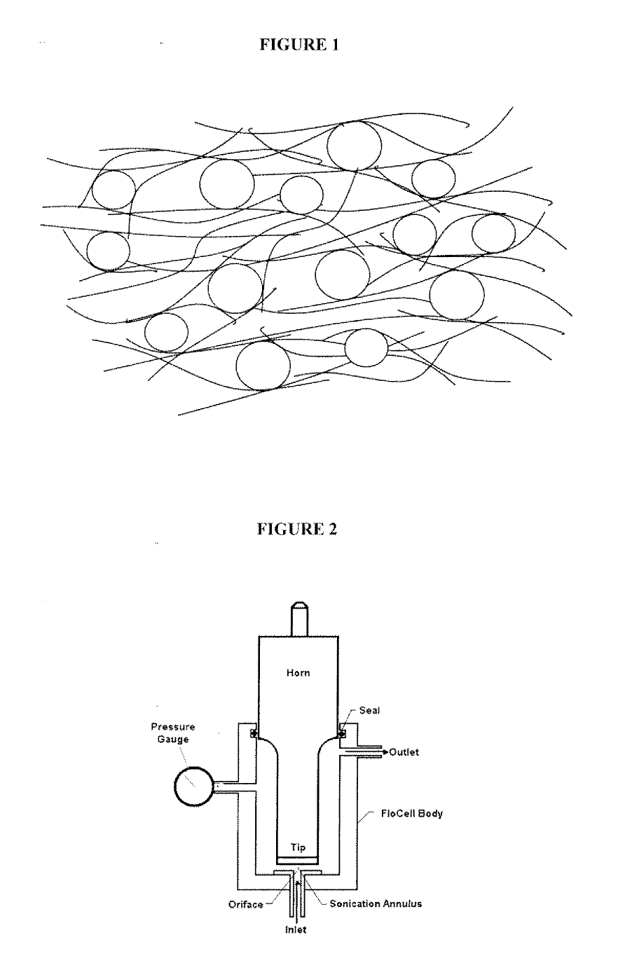

The highly dispersed and entangled CNT network may advantageously provide high electrical conductivity, mechanical strength, and durability. The high aspect ratio of the entangled CNTs also may allow for the incorporation of micron-sized particles or fibers within the network structure. A schematic illustration of one embodiment of a CNT-particle combination is provided in FIG. 1, which shows a network of CNTs supporting numerous particles. Furthermore, the absence of polymer binders, which decrease usable surface area, may allow for maximum ion-particle interactions.

The use of CNTs as a functional matrix is a unique approach for creating advanced composite materials. With this approach, an additive with desired properties (e.g., silicon particles, highly microporous aC particles, or particles of a lithium containing compound, etc.) can be utilized, with the added benefit and functionality of the unique properties of the CNTs. For example, in the composites made as described herein, the CNTs may be able to provide a large active surface area in addition to highly conductive pathways throughout the material.

1. Carbon Nanotubes

Since carbon nanotubes can have a wide variety of properties and characteristics, the choice of raw CNT materials may impact the properties of the resulting composite sheet. As previously stated, the CNTs used herein may be SWNTs, MWNTs, carbon nanofibers, or any combination thereof.

Generally, any SWNTs or MWNTs or combination of MWNTs and SWNTs may be used in the composite materials described herein, including those that are commercial available.

In some embodiments, a smaller diameter (for example, <20 nm) and a longer length (for example, >1 micron) is preferred for the CNTs due to the large aspect ratio and good ability to form a network for hosting a higher loading percentage of particles. CNTs with longer lengths may provide enhanced electrical conductivity, mechanical integrity, and may offer more flexibility in terms of particle type, size, or concentration with which it can be combined. If the diameter of the CNTs is too large, however, it could decrease surface area, decrease electrical properties, and may also limit the structural integrity due to weak entanglement and CNT-CNT interactions.

2. Embedded Material

A variety of particulate or fibrous materials may be combined with the CNTs to form the binder-free composite material. A variety of sizes of the particles or fibers may be suitable for the composite. The size of the particles in the composite material may be selected depending on the particular application or use of the material.

Particles, such as microparticles, which exceed the pore size of the composite advantageously provide a stable and reliable electrical connection between the CNTs and particles. For example, when particles of sizes from 1 to 100 μm are used, the particles' size fosters and ensures a reliable electrical connection between the components of the composite.

In one embodiment, the size of the particles is in the micron range, for example, from 1 to 100 μm. In one particular embodiment, the particles range in size from about 1 to about 20 μm. In another particular embodiment, the particles range in size from about 1 to about 15 μm. In yet another particular embodiment, the particles range in size from about 1 to about 10 μm. In still another particular embodiment, the particles range in size from about 1 to about 5 μm. Smaller particles, e.g., less than 1 μm (e.g., <50 nm silicon particles) may also be acceptable in limited circumstances, such as when MWNTs are used as the network. Larger particles may also be suitable in certain embodiments.

In other embodiments, particles may have specific functions/properties/characteristics which could be exploited in the composite materials described herein for a variety of applications. The choice of particle type is application-specific depending on what properties are desired from the embedded particles, or what functions the composite materials are intended to perform.

For instance, in one embodiment, silicon particles may be selected so that the composite material will be useful in electrical devices. In another embodiment, silicon particles may be embedded in the composite materials so that the material may be used as an electrode, especially an anode, in a Li-ion battery.

In another embodiment, aC particles may be selected for their high microporous surface area, which is useful in electrochemical capacitor electrodes. aC particles were utilized in the CNT network composite framework to create porous self-supporting sheets of 100% carbon (excluding any impurities within the carbon raw materials), which are highly conductive with very large surface areas. The aC particles introduce large specific surface areas composed predominantly of micropores. Such surface texture properties are desirable for devices such as electrochemical capacitors which utilize non-faradaic ion adsorption to store electrical energy.

In yet another embodiment, particles of lithium compounds may be selected. The composite materials containing particles of lithium compounds may be used as electrodes for lithium-based energy storage devices (Li-ion batteries, capacitors or hybrid devices). In some embodiments, the lithium-based particles may be selected from lithium iron phosphate (LiFePO₄), lithium manganese oxide (LiMn₂O₄), lithium cobalt oxide (LiCoO₂), lithium nickel oxide (LiNiO₂), other lithium oxides or phosphates, or any combination thereof.

In other embodiments, the particles may be selected from metals, semiconductors, non-metals, alloys, oxides, and combinations thereof. In one embodiment, the particles may be selected from Ge, GeAs, SnTe, InAs, CdSe, TiO₂, GaSb, InSb, SnSe, GaP, InP, AlP, AlAs, ZnTe, CdSe, CdTe, alloys thereof, or any combinations thereof. In another embodiment, the particles may be selected from Sn, Al, Fe, Au, Ag, Pt, Ni, Ti, V, Cu, Pd, Pt, In, Co, Zn, Mn, Pb, Rh, Li, Na, alloys thereof, oxides thereof, or any combination thereof. In yet another embodiment, the particles may be sulfur particles.

The embedded material in the composite materials described herein is not limited to low aspect ratio particles. In some embodiments, fibrous materials are combined as the ‘additive’ in the CNT networks. For example, these may be carbon nanofibers (CNF) or carbon fibers. In a particular embodiment, the fibers may be silicon fibers. In another embodiment, the fibers may be metal fibers. Rod-like structures of any chemical composition may be incorporated into the CNT matrix as well. Samples of CNT-CNF have been fabricated.

3. Ratio of Components

The amounts and ratios of components in the composite materials described herein may vary, for example, depending on the particular application or use of the composite material. In one embodiment, the composite material includes between about 5% and about 99% by weight of the particles, the balance being essentially or entirely CNTs. In another embodiment, the composite material includes between about 5% and about 90% by weight of the particles, the balance being essentially or entirely SWNTs. In yet another embodiment, the composite material includes between about 5% and about 95% by weight of the particles, the balance being essentially or entirely MWNTs.

Other amounts or ratios of CNTs and particles in the composite materials are envisioned for other embodiments. For instance, one may choose an optimum ratio to provide a particular electrical conductivity, surface area, or ratio of active material with another electrode. As indicated by Table 2 in the Examples below, increasing the percentage of CNTs in one particular composite material increased the electrical conductivity, while increasing the percentage of aC particles in the particular composite material increased the surface area, but lowered conductivity. For example, one device may require a surface area that is as high as possible, with the reduction of conductivity being acceptable.

Generally, the limitation of the weight fraction of particles which is achievable within CNT networks while maintaining the structural integrity of the electrode is an important concept. The motivation of replacing polymer binders with CNT networks would lose attractiveness if a significant portion of the electrode mass must come from the CNTs in order to support the active particles. Even though the CNTs may provide some benefit to energy storage (as opposed to the completely inactive polymer binder), higher weight fractions of active particles are always desirable due to the effect on the maximum theoretical capacity and specific energy which is achievable. The dimensions of the CNTs and the particles may effect the particle loading. Not wishing to be bound by any particular theory, the particle loading limitation may not be based on weight fractions, but rather a volumetric phenomenon. Particles with larger densities may be able to achieve higher weight fractions than particles with smaller densities. Appreciation of these concepts may facilitate maximization of the weight percentage load for each type or particle or particles used in the composite materials described herein.

4. Composite Optimization and Functionalization

For additional versatility, the CNTs in the composite materials described herein can be tailored based on a particular application's requirements. For example, various chemical or physical activation processes can increase the specific surface area. In addition, a number of different chemical functionalization procedures can be completed to modify the surface chemistry of the CNTs. Functionalization, as used herein, refers to the addition of at least one functional group to the CNTs, or any other alteration that improves either the stability of the suspension formed with the CNTs, or the physical, mechanical, electrical, or chemical properties of the CNTs. See, for example, Kamaras, K. et al. SCIENCE, Vol. 301, September 2003.

Through functionalization, it may be possible to achieve an increase in electrical conductivity, more efficient electrochemical performances, increased interfacial compatibility with surrounding environment (e.g. choice of electrolyte), and the addition of psuedocapacitive groups on CNT surfaces to increase energy storage properties, etc.

Chemical doping to increase the number of charge carriers within CNTs can significantly improve the electrical conductivity of the CNT networks. The increased conductivity and ability to modify charge carrier concentrations of the composite material may provide significant advantages for the end applications. See, for example, Chandra, B. CHEM. MATER. 22, 2010, 5179-5183.

### Process of Making the Composite

1. Suspension Formation

Before any of the filtration methods described herein are performed, a suspension of CNTs and one or more desired particles is formed. In some embodiments, the suspension is a stable suspension. In other embodiments, the suspension is a semi-stable suspension. Generally, the suspension may be formed using any suitable liquid, including, but not limited to, aqueous, organic, inorganic, other solvents, ionic liquids, or any combination thereof.

A number of surfactants may be incorporated into the liquid to aid in the dispersion of the CNTs in suspension. In some embodiments, one or more surfactants may be added. In one embodiment, one or more surfactants is added to the suspensions containing water or another aqueous solution. Typically, the surfactant acts as a dispersant aid. Any suitable surfactant may be used; for example, Triton X-100® (BASF, Ludwigshafen, Germany), sodium dodecylbenzene sulfonate (SDBS), or sodium dodecyl sulfate (SDS). In one embodiment, the surfactant concentration in the suspension may be higher than the critical micelle concentration (cmc) for the particular surfactant that is used.

In another embodiment, the liquid comprises an organic compound (such as an alcohol, ketone, or other organic solvent). In one particular embodiment, the liquid comprises isopropanol. In another particular embodiment, the liquid comprises N,N-dimethylformamide (DMF). In other embodiments, the liquid comprises chloroform, ethanol, dichloromethane, N-methylpyrrolidone (NMP), 1,2-dichlorobenzene (o-DCB), or dimethyl sulfoxide (DMSO). In other embodiments, the liquid may comprise a combination of one or more of the solvents disclosed herein. It is also envisioned that the suspensions can be made using other inorganic solvents or other organic solvents.

In some embodiments, the concentration of total solids (CNTs and particles/fibers) in the suspension may range from less than about 4*10⁻⁵ mg/mL to more than about 20 mg/mL. In one embodiment, the concentration of total solids is about 15 mg/mL or less. In another embodiment, the concentration of total solids is about 10 mg/mL or less. In yet another embodiment, the concentration of total solids is about 5 mg/mL or less. In still another embodiment, the concentration of total solids is about 1 mg/mL or less.

In one embodiment, the suspension is formed with functionalized CNTs. In another embodiment, functionalized CNTs may form a stable dispersion without the aid of a surfactant.

In one embodiment, a high energy dispersion process may be used to facilitate formation of the suspension. For example, the high energy dispersion process may include ultrasonication, microfluidizer high shear fluid processing, homogenizers, colloid mills, or any combination of these techniques.

Formation of the suspensions described herein may be assisted by probe sonication with a Sonicator 4000® manufactured by Qsonica, LLC. To improve the efficiency and effectiveness of the sonication process, a Flocell may be used with the sonication probe. The Flocell is an enclosed chamber which fits over the tip of the sonication probe, and allows for continuous flow-through processing. The Flocell not only increased throughput, it also reduced the process variability and increased the control of influential factors. Table 1 below shows some of the important factors that may be controlled when using the Flocell sonication process.

TABLE 1
Factors controllable with Flocell sonication process

| Factor | Typical Settings |
|---|---|
| Pump flow rate | 50 mL/min to more than 1000 |
| | mL/min |
| Sonicator output amplitude | 50%-100% |
| Flocell internal pressure | 0 psi to 30 psi |
| Number of passes through Flocell | 1-10 |

A schematic of the Flocell and sonication probe, commonly referred to as a horn, is shown in FIG. 2. Peristaltic pumps may be used to pump the suspension through the Flocell to enable the suspension to undergo processing.

Generally, the suspension is formed by dispersing CNTs and any desired particles or fibers in a liquid to form a stable or semi-stable suspension. In one particular process, CNTs and silicon particles are first dispersed in a liquid to create a stable or semi-stable suspension. In another particular process, CNTs and particles of a lithium compound are first dispersed in a liquid to create a stable or semi-stable suspension. In yet another particular process, CNTs and aC particles are first dispersed in a liquid to create a stable or semi-stable suspension.

2. Filtration

In one embodiment, a filtration method is used to make the composite. In this embodiment, a dispersed suspension of CNTs and the desired particles or fibers is formed as previously described, and then filtered through a membrane to obtain porous freestanding composite sheets or films or papers. In one particular embodiment, the composite material is filtered using a microporous membrane. In one embodiment, the composite structure is made by a wet filtration process.

In some embodiments, the filtration is aided with vacuum and/or positive pressure, to drive the liquid through the membrane. A variety of membrane materials may be used. In one embodiment, the membrane materials have pore sizes in the sub-micron range. Manufacturers such as Millipore, Sterlitech, and Whatman produce a number of different membrane materials that can be used in this process. For example, the Millipore immobilon Ny+ membrane (product # INYC00010) is one example of a versatile membrane which has been successfully used.

Typically, the CNTs and particles deposit onto the membrane surface during filtration of the suspension. The deposition of the CNTs and particles generally produces a filter cake. The filter cake is not a paste, nor is it a paste when it is dried.

Upon drying, the filtered material generally configures into a solid sheet (carbon nanotube network and embedded particles) and may be peeled off of the filtration membrane. In some embodiments, the solid sheet is an entangled network of high aspect ratio CNTs that surrounds, or entraps, the particles.

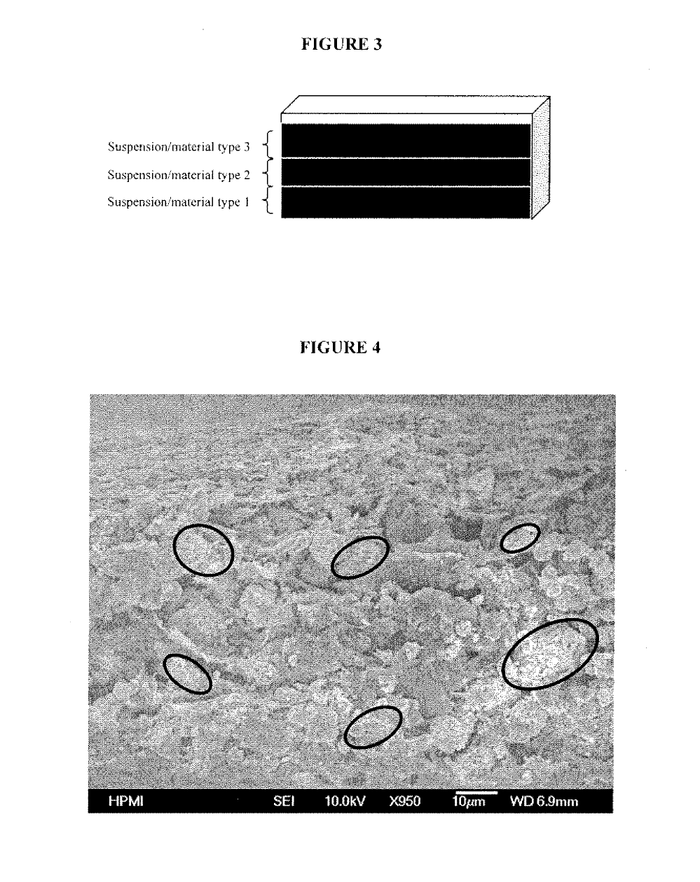

As opposed to mixing materials together into one suspension, they can be mixed by creating individual suspensions for each constituent material or for different ratios of constituent materials, and then filtered in succession of one another. That is, separate types of suspensions can be alternately filtered in a layer-by-layer type process. This method can be used to control the nanostructure of the material as depicted in FIG. 3. In some embodiments, the successive filtrations do not require drying in between the filtration steps; rather, the successive filtrations may be done one directly after another. Alternatively, the layers may be dried before applying the next.

Using this layer-by-layer method, composite materials may be fabricated that have the following sequences of layers: pure CNTs/CNTs and particles; pure CNTs/CNTs and particles/pure CNTs (see Example 4); CNTs and particles/pure CNTs; or any other beneficial combination.

The ability to create composite materials with tailored microstructures, including, for example, one or more layers of pure CNTs is advantageous for a number of reasons. With their higher electrical conductivity, dense surface layers of pure CNTs could rapidly distribute electrons along the length and width of the sample. The lower conducting path through the CNT networks which have embedded particles is minimized to the thickness of the material (tens of microns versus several centimeters if required to travel the length/width of the electrode). Minimizing the distance the electrons are required to travel in the lower conducting regions of the electrode can improve the efficiency of the energy storage processes. This is the same motivation and reason why metallic current collectors are used in traditional electrodes. However, the composite materials described herein may utilize engineered microstructures in combination with the high conductivity and lows mass density of CNTs to remove metallic current collectors while reducing concerns of the detrimental effects which may arise.

If a surfactant is present in the CNT-particle suspension, there may be residual surfactant within the material after fabrication. While this surfactant may be in concentrations as high as 50% by weight, it can be removed if desired. Removing the surfactant may improve a number of properties of the composite, including, but not limited to, electrical conductivity and accessible surface area. Washing the composite material in various solvents may remove a majority or other portion of the surfactant. In some embodiments, suitable wash solvents may include isopropanol, ethanol, methanol, acetone, other organic solvents, or any combination thereof. In some embodiments, it may be possible that about 5 weight % to about 20 weight % residual surfactant may still remain in the composite material even after several washing procedures.

In one embodiment, all of the surfactant in or on the composite material may be completely or substantially completely removed by using a heat treatment process at temperatures greater than the surfactant decomposition temperature. For instance, Triton X-100® surfactant can be removed at a temperature range from about 250° C. to about 500° C., or greater, in a high-temperature oven or tube furnace. Other surfactants may have a different decomposition temperature range.

Generally, the heat treatment length would depend on the temperature used. The optimum combination of temperature and heating duration may be determined for the particular materials used. In one embodiment, a temperature of about 500° C. for at least 1 hour is used. In one embodiment, a temperature of about 450° C. for at least 1 hour is used. In one embodiment, a temperature of about 400° C. for at least 1 hour is used. In one embodiment, a temperature of about 350° C. for at least 1 hour is used. In one embodiment, a temperature of about 300° C. for at least 1 hour is used. In one embodiment, a temperature of about 250° C. for at least 1 hour is used. In one embodiment, the heat treatment is conducted in an inert atmosphere (e.g. vacuum or nitrogen) to prevent oxidation of the carbon material or other deleterious effects.

After the heat treatment process, the remaining moisture and decomposition byproducts optionally may be removed from the composite material, for example by a washing and/or drying procedure. Such a procedure may be used to create a composite material that is composed solely of the CNT matrix and the embedded particles.

In certain embodiments, the resulting composite sheet is chemically treated. For example, various chemical treatment methods are known in the art to increase surface area and/or electrical conductivity.

The processes described herein may be conducted in a batch process or in a continuous process. For example, the process may adapt the continuous fabrication technologies and techniques described in U.S. Pat. No. 7,459,121 to Liang, et al., which is incorporated herein by reference,

### Uses of the Composite Materials

The composite materials made as described herein have many possible applications. For example, the composite materials containing silicon particles, aC particles, or particles of lithium compounds may be porous with high electrical conductivity, large surface areas, low mass densities, and high durability. These properties lead to many possible applications such as electrodes in energy storage units (batteries, electrochemical capacitors and fuel cells), water purification systems, hydrogen storage materials, gas purification, and other possible applications which may benefit from the said properties. The general concept of embedding functional particles within a CNT matrix to create multifunctional composite materials may be extended to even more applications, depending on the functions of the additive particle.

The composite materials can have a multitude of uses where high surface area, low electrical resistivity, low mass density and the chemical or electrochemical properties of carbon are desired. These applications include but are not limited to: batteries, fuel cells and electrochemical capacitor electrodes, water purification systems (capacitive deionization electrode, membrane filtration), hydrogen storage materials, gas purification, etc.

Specifically, surrounding silicon particles with porous CNT networks may create a structure which provides room for the particles to expand into, while maintaining support and electrical contact. This could allow for the realization of high energy density silicon based anodes with long cycle life.

The materials described herein, including the composite material containing CNTs and aC particles, can also be used as a material to desalinate water through capacitive deionization. The function is the same as that of the electrochemical capacitor, except the electrolyte is the salt water which is undergoing desalinization. Applying a potential to the device will attract the ions to the electrode surface, thereby removing the ions. This deionized or desalinated water is sent through the device while the ions are held on the surface. Then a second water source, the ion “removal stream” goes through the device to clean the electrodes. While the removal stream is passing through the device, the potential is removed and the ions will no longer be attracted to the electrode surface and will be carried out of the system by the removal stream. The process is then repeated.

The present invention is further illustrated by the following examples, which are not to be construed in any way as imposing limitations upon the scope thereof. On the contrary, it is to be clearly understood that resort may be had to various other aspects, embodiments, modifications, and equivalents thereof which, after reading the description herein, may suggest themselves to one of ordinary skill in the art without departing from the spirit of the present invention or the scope of the appended claims. Thus, other aspects of this invention will be apparent to those skilled in the art from consideration of the specification and practice of the invention disclosed herein.

### Example 1

### Fabrication of Composite Containing Silicon Particles

In this example, electrode samples were fabricated using SWNTs to support silicon particles. Silicon powder (99.9985% pure) with an average particle size of 1-20 micron and crystalline/amorphous structure was purchased from Alfa Aesar (product no. 38715). The SWNTs were purchased from SouthWest NanoTechnologies (SWeNT CG200), and had an average diameter of 1.01+/−0.3 nm, an aspect ratio of 1,000, a carbon content greater than 90%, and a relative purity (percentage of carbon that is SWNT) greater than 90%. The silicon and SWNTs in this example were used as-received, without further purification or modification.

An 80:20 ratio of Si particles and SWNTs was mixed with deionized water and the surfactant Triton X-100®. The concentration of solids (SWNTs and silicon particles) was 0.2 mg/mL and the surfactant's concentration was 2 mg/mL.

Formation of the suspension was assisted by probe sonication with a Sonicator 4000 manufactured by Qsonica, LLC, as previously described. A Flocell was also used.

The Flocell model B used in this example was purchased from Qsonica, LLC, and used with a ½″ titanium tip probe. Peristaltic pumps were used to pump the suspension through the Flocell to enable the suspension to undergo processing.

The flow rate through the Flocell was 500 mL/min and the suspension was cycled 5 times using 50% output amplitude with no internal pressure. The filtration membrane was polycarbonate track etch (PCTE) membrane from Sterlitech Corporation (product no. PCT0447100) with 0.4 micron pore size. This membrane has a flat surface with individual pores that pass through the entire thickness of the membrane to allow for easy removal of the sample. Such membranes do not trap or adhere a large amount of CNTs to the surface, unlike those which have an intertwined web-like structure.

The residual surfactant was removed, and the materials were filtered, dried, and isolated using the techniques and methods previously described herein.

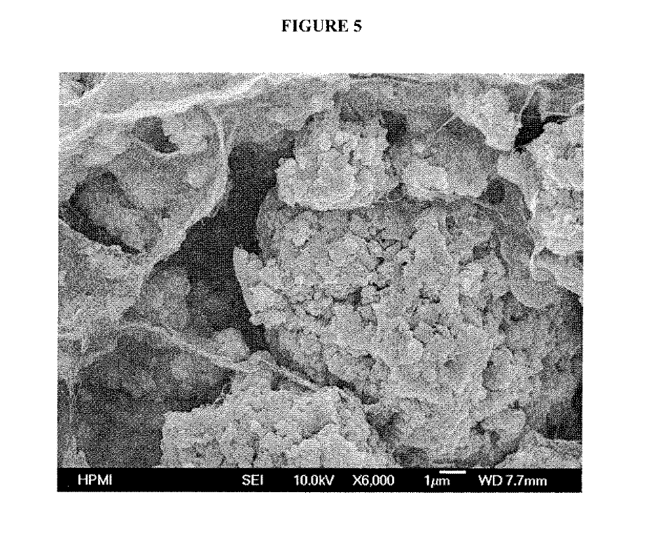

A flexible freestanding sheet was obtained which had an approximate thickness of 75 microns. Although the Si particles purchased from the vendor had a large size range, 1-20 micron, the particles appeared to be uniformly distributed throughout the sample as seen in the cross-section SEM image in FIG. 4.

In FIG. 4, the silicon particles have a large size distribution and a jagged surface. The jagged surface is clear in the SEM image in FIG. 5. The jagged edges of the large Si particles give the appearance of a cluster of smaller particles. Networks and bundles of CNTs can be seen in FIG. 5 connecting various particles together with the bulk SWNT networks.

It is important to note that the cross-sectional views for these images were obtained by applying a tension force on the sample until it fractured. The surface in the figures is actually a fractured surface, and is not necessarily representative of the exact structure found within the material before it is fractured. However, these cross-section images give an idea of the particle distribution in the material and how the particles and CNTs may interact.

### Example 2

### Constant Current Charge Test on Composite Material

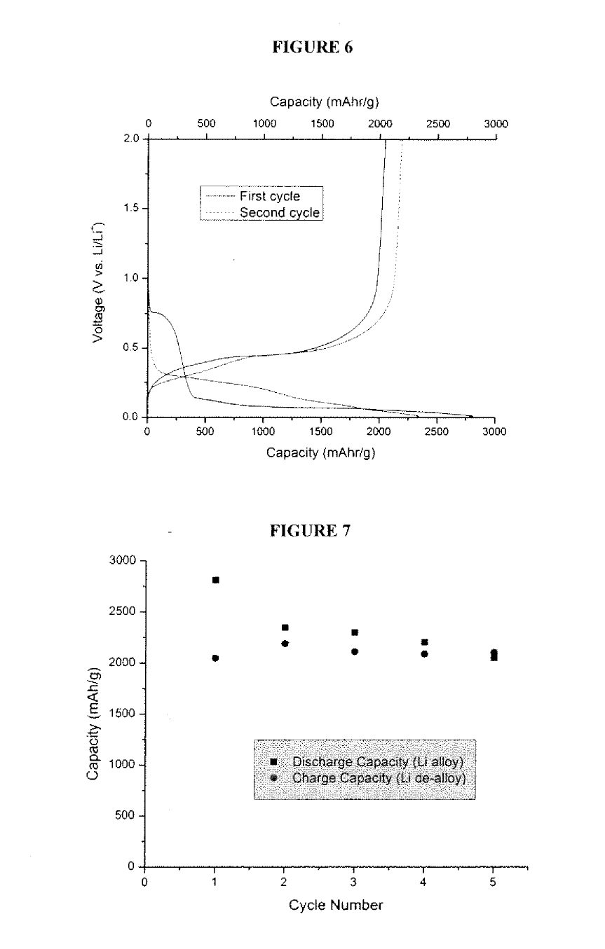

A constant current charge-discharge test was performed on the Si:SWNT (80:20) composite material from Example 1. The electrode was assembled in a Swagelok T-cell versus lithium metal foil with 1 M LiPF₆ in EC:DMC:DEC (1:1:1) electrolyte. A constant current of 143 mA/g was applied for charging and discharging between 0.01 V and 2.0 V. The charge-discharge profiles are shown in FIG. 6, and depict the high specific capacity for the composite electrode.

FIG. 7 summarizes the charge and discharge capacities for 5 cycles. There was a large irreversible capacity on the first cycle due to SEI formation on the SWNT surface. The change in shape of the voltage vs. capacity profile from the first to second cycle confirmed that the capacity loss was due to the irreversible SEI formation which occurs on all carbon electrodes used in Li-ion batteries. See Landi, B. J. et al. J. MAT. RES. 25, 2010, 1636-1644.

The first cycle discharge capacity of 2800 mAhr/g approached the theoretical capacities for an electrode of 80% Si and 20% SWNT (˜3400 mAhr/g). The electrode displayed capacities over 2000 mAhr/g after 5 charge-discharge cycles indicating the CNT networks are maintaining the structural integrity and electrical connections within the material.

### Example 3

### Fabricating Composite Material With Si:MWNT (80:20)

Using the procedures of Example 1, composite materials containing silicon particles and MWNTs in an 80:20 ratio were fabricated. The MWNTs were purchased from CNano Technologies Limited (FloTube 7000b), and had lengths up to 50 micrometers, outer diameters from 6-8 nm, and a 93% purity, according to the supplier. The silicon particles were the same as those used in Example 1. The silicon and MWNTs materials in this example were used as-received, without further purification or modification.

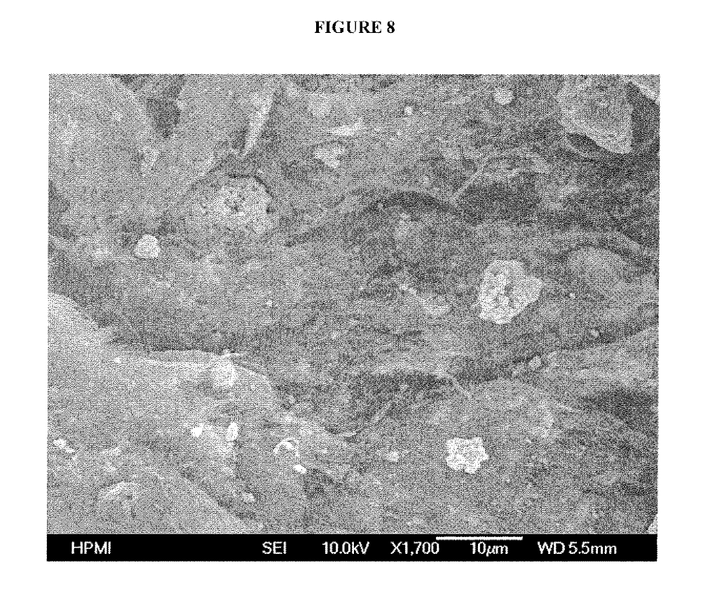

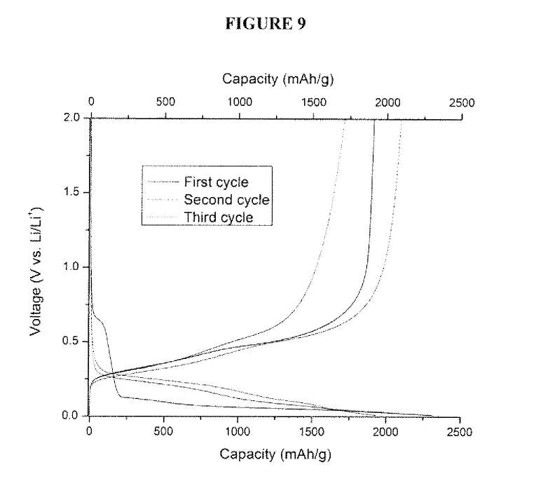

The resulting composite material was freestanding and highly flexible with a thickness of approximately 115 micron. The cross-section SEM image in FIG. 8 shows the silicon particles entangled in MWNT networks and distributed throughout the sample.

For the composite material containing Si:MWNT (80:20), the charge-discharge capacity profiles versus voltage for the first three cycles are shown in FIG. 9. The electrode was assembled in a Swagelok T-cell versus lithium metal foil with 1 M LiPF₆ in EC:DMC:DEC (1:1:1) electrolyte. A constant current of 150 mA/g was applied for charging and discharging between 0.01 V and 2.0 V. The results showed that high lithium storage capacities of over 1500 mAhr/g were achieved. The SEI formation and associated capacity loss was evident in the Si:MWNT (80:20) sample.

### Example 4

### An Si:SWNT (80:20) Composite Material with Engineered Microstructure

A pure SWNT suspension containing about 5 mg of SWNT and 50 mg of the surfactant Triton X-100® in 250 mL water was poured onto the filter described above in Example 1. The SWNTs in this suspension accounted for 5 weight percent of the final electrode mass. Vacuum force was then applied to induce the filtering. When the filtering was nearly complete (less than about 100 mL of water left to filter through the membrane), a second suspension containing 10 mg SWNT and 80 mg of silicon particles was poured onto the filter. The SWNTs in this second suspension accounted for 10 weight percent of the final electrode mass, while the silicon particles accounted for 80 weight percent of the final electrode mass. As the second suspension nearly completed filtering (less than about 100 mL of water left to filter through the membrane), a third suspension, identical to the first, was added and filtered.

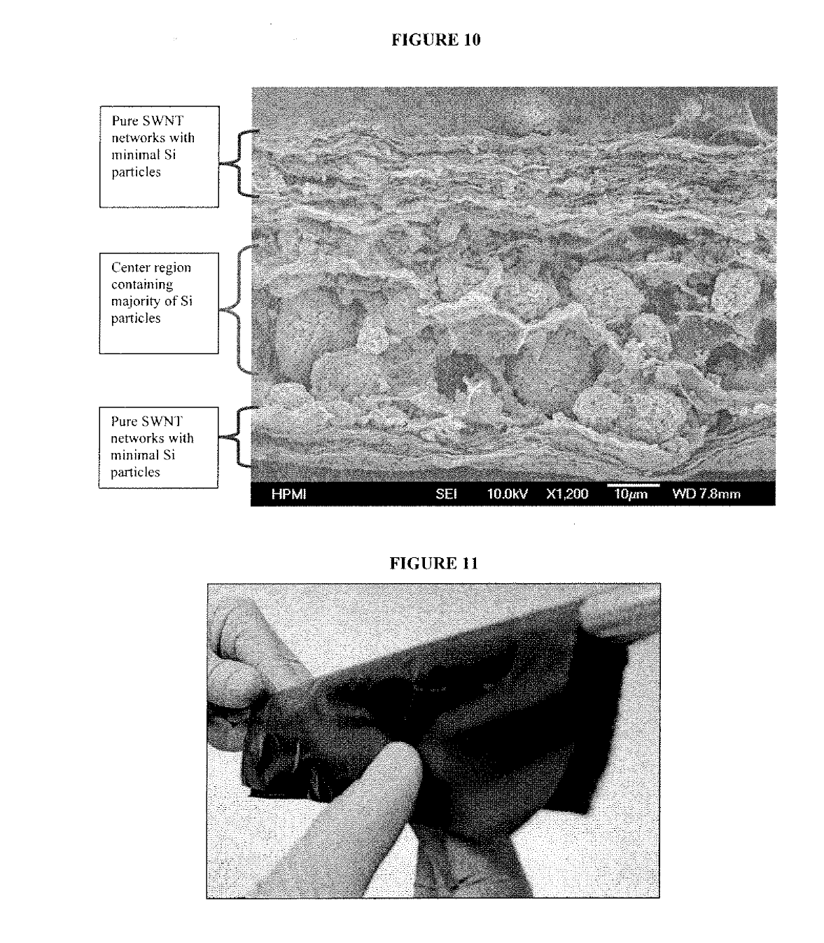

This process methodology allowed for thin layers of pure CNTs, in this case SWNTs, to be placed at the top and bottom of the electrode to “sandwich” the silicon particles and CNT network middle portion. The sandwiching effect of the surface layer of pure CNT networks may provide better retention of embedded particles and enhance electrical properties for the electrode. The cross-section SEM image in FIG. 10 shows the engineered microstructure created using the layer-by-layer filtration scheme of this example.

The dense network of pure SWNTs at the surfaces of the sample may provide benefits for removing metallic current collectors from batteries and electrochemical capacitors. The major concern with the removal of metal current collectors is the possible increase of the electric potential which could exist within the length/width of a single electrode if the conductivity is not high enough. The sandwich structure could minimize the potential difference by providing higher conducting regions for the current to travel which will minimize in-plane potentials within the electrode.

### Example 5

### Composite Material Made with aC Particles for Electrochemical Capacitors

The aC particles used had a 4.5 micron average particle size and 1400 m²/g BET specific surface area. The single-walled nanotubes used were Elicarb® SWNTs from Thomas Swan & Co. Ltd., with >70% purity, 0.9-1.7 nm average diameter, ˜700 m²/g BET surface area, and a maximum of 5 weight percent metal oxide content, as reported by the product data sheet.

The experiments in this example were conducted using the Elicarb® SWNTs unless otherwise noted. Two supplementary results are shown which used CG200 SWNTs from SouthWest NanoTechnologies. All the CNT batches were used as-received without further modification.

Samples were fabricated with a ratio of SWNTs to aC particles from 0 weight percent aC particles (pure SWNT sheet, also known as “buckypaper”) to 50 weight percent aC particles (1:1 weight ratio of aC to SWNT).

A co-filtration method was utilized where a well-dispersed suspension of SWNTs and aC particles was filtered through a microporous membrane to obtain free-standing composite sheets or films. The fabrication process first required the creation of a stable or semi-stable suspension containing the SWNTs and aC particles.

All suspension were created by probe sonication with the Sonicator 4000 from Qsonica L.L.C. Surfactant-assisted dispersions were created in deionized water with a concentration of total solids at 40 mg/L for all samples. The non-ionic surfactant Triton X-100® was used at concentrations of approximately 400 mg/L to aid in particle dispersion.

The suspension was then filtered through a 0.4 micron pore size nylon membrane purchased from Millipore. During filtration, the SWNTs and aCs were deposited onto the membrane surface, thereby creating a filter cake. Upon drying the filter cake, the high aspect ratio SWNTs created an entangled network surrounding the aC particles, and a free standing sheet was obtained.

The residual surfactant was removed with a two hour bath in isopropyl alcohol followed by heat-treating the sample at 500° C. under a nitrogen gas atmosphere for 1 hour. The full removal of the surfactant was confirmed by thermogravimetric analysis (TGA). The high thermal stability and hinder-free characteristics of the material are also evidenced by the TGA plot in which negligible weight loss occurred up to 800° C. under a nitrogen gas atmosphere.

The weight percentage of activated carbons within the sheets was varied to explore the effect on surface area and electrical properties. Surface area measurements were performed using the nitrogen adsorption method with the TriStar 3000® Surface Area and Porosity Analyzer from Micromeretics. The sheet resistance was measured using the four-wire method with the force current, measure voltage (FCMV) scheme. The reported electrical conductivity is the reciprocal of the resistivity gained from the measured sheet resistance.

All samples were highly flexible with thicknesses of ˜40 microns and an aerial density around 1-2 mg/cm². The flexibility is displayed by the bending of the 50:50 weight ratio sample shown in FIG. 11.

The effect of increasing the concentration of aC particles in the material is summarized in Table 2. The surface area and electrical conductivity was significantly affected by the addition of aC into the SWNT networks.

TABLE 2
Electrical conductivity and surface area characterization
results of various SWNT-aC mixtures.

| | | | t-Plot | Avg | Electrical |
|---|---|---|---|---|---|
| | | BET | Micropore | Pore | Con- |
| | Wt % | Surface | Area | Size | ductivity |
| Sample | aC | Area (m²/g) | (m²/g) | (nm) | (S/cm) |
| aC powder | — | 1406 | 1006 | 2.1 | 0.1-1 * |
| SWNT powder | — | 733 | 14 | 6.4 | 1 |
| SWNT | 0% | 593 | 0 | 6.3 | 150 |
| SWNT:aC 7:1 | 13% | 643 | 81 | 5.5 | 117 |
| SWNT:aC 3:1 | 25% | 697 | 184 | 4.2 | 67 |
| SWNT:aC 1:1 | 50% | 953 | 421 | 3.4 | 36 |

* See Wei, Y. Z. et al. J. OF POWER SOURCES, 141, 2005, 386-391.

### Example 6

### Microstructure of aC-CNT Electrode Materials

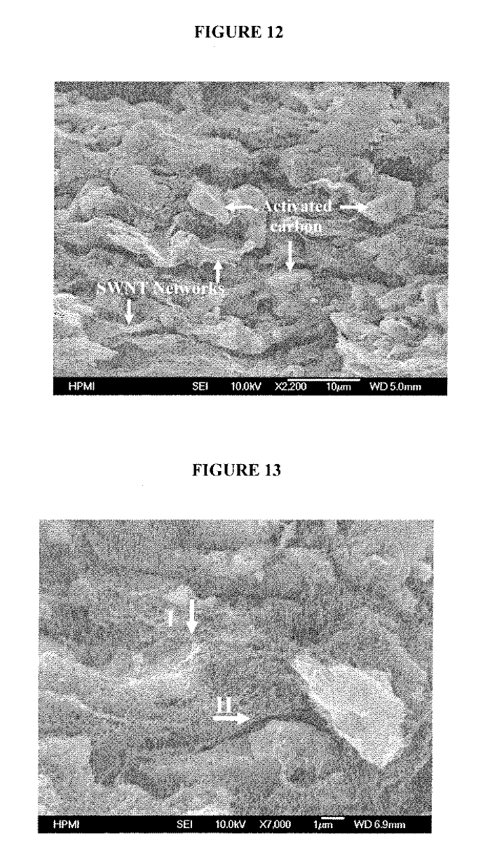

SEM was utilized to view the microstructure of the composite materials created in Example 5. In the SEM image in FIG. 12, a uniform distribution of aC particles can be seen throughout the thickness of the sample. The sheet-like network configurations can been seen surrounding the aC particles.

In SEM images taken from the top and bottom of the sample, a uniform distribution of particles was also observed. The uniform particle distribution throughout the material was achieved because of the use of the surfactant stabilized suspension in the fabrication or filtration process. Because the CNTs and aC particles were well-dispersed in the suspension, filtration of the suspension resulted in a uniform deposition of the particles within the filter cake. Since solids in the suspension will begin to agglomerate after the dispersion process, the time between dispersion and filtration was minimized in order to achieve a uniform particle distribution.

From the cross-section SEM images it appeared that the SWNTs formed into dense sheet-like networks surrounding the aC particles. The cross-section surface was obtained by applying a tension load until the sample fractured. At the surface, various morphologies of aC-SWNT interactions were observed. Some aC particles had SWNTs extending from their surface, and appear to be embedded within the SWNT network. Most particles, however, appeared to be sandwiched between dense SWNT networks which have smooth surfaces. The SEM image in FIG. 13 shows both of these types of interactions. The interaction labeled “Type I” is an aC particle with SWNT bundles extending out from the network and wrapping around the surface. The “Type II” arrow points to a smooth surface of the SWNT network that had minimal interaction with the particle surface.

### Example 7

### Electrical Conductivity of the Composite Materials

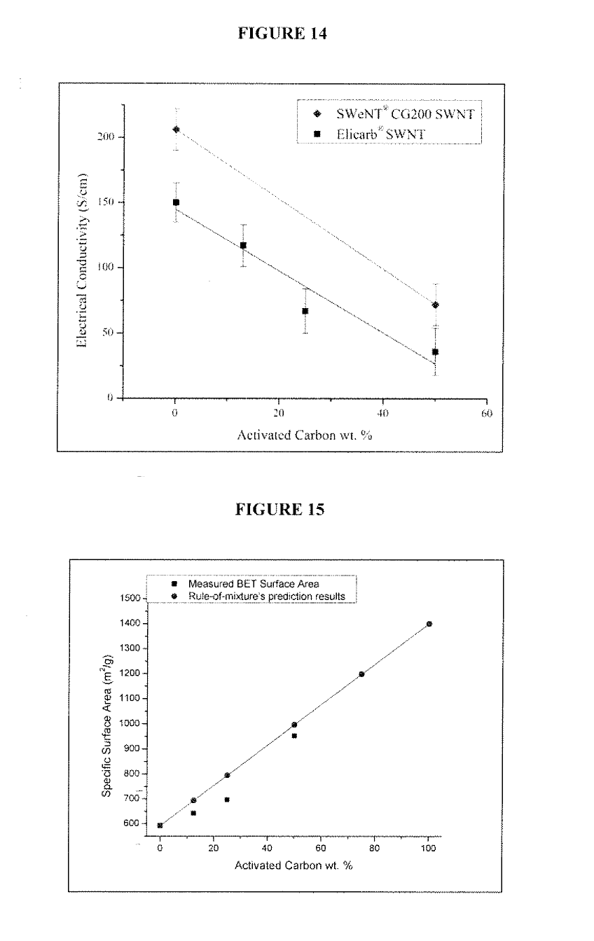

The electrical conductivities of the composite materials from Example 5 were measured. The electrical conductivity of the composite samples decreased with the increasing percentage of aC particles. However, even for the sample with 50 weight percent of aC particles, a measured electrical conductivity of 36 S/cm was achieved, which is significantly higher than the conductivity of aC electrodes. It should be noted that the conductivity values were dependent on the type of CNTs used, and essentially a function of the conductivity of the pure CNT sheet. To demonstrate this phenomenon, samples were fabricated using a more conductive SWNT batch from South West Nanotechnologies Inc. FIG. 14 shows that the resulting composite electrodes' conductivity was a function of the conductivity that can be achieved for the pure CNT sheets.

The relationships in FIG. 14 indicated that electrical conductivity of the composite materials described herein can be tailored by the selection of CNT material. The results in FIG. 14 could be improved by increasing the conduction properties of the CNTs and CNT network. For example, even with a 76% reduction in conductivity from the pure SWNT sheet to a 1:1 aC:SWNT composite (observed percentage decrease in the current results), a conductivity of over 1000 S/cm would be achieved if the pure CNT sample had a conductivity of 6000 Stem (the conductivity achieved in the work by Park et al. “Electromagnetic interference shielding properties of carbon nanotube buckypaper composites,” NANOTECHNOLOGY, Vol. 20, 2009). Higher conductivity in CNT networks may be obtained by using longer CNTs, through sample purification, chemical treatments, and with the use of metallic rich CNT batches.

### Example 8

### Surface Area and Pore Size Analysis of Composite Materials

The surface areas and pore sizes of the composite materials of Example 5 were measured. The specific surface areas of the aC-SWNT composites were found to be an intermediate value between the SWNT network surface area and the aC surface area. This relationship can be modeled using the rule-of-mixtures approach as shown in formula (1).

SSA_{C}=SSA_{aC}w_{aC}+SSA_{SWNTnet}(1−w_{aC}) (1)

In this formula, SSA_{c} is the specific surface area of the composite, SSA_{SWNTnet} and SSA_{aC} are the BET surface areas of the SWNT networks and aC powders, and w_{aC} is the weight fraction of the activated carbon in the sample.

The model results and experimentally measured data are shown in FIG. 15. The contribution from each constituent material is evident in the model, as the first and last data points are the measured BET SSA for the SWNT powder and aC powder, respectfully.

From the experimental data and prediction model, it was clear the resulting electrode surface area was a function of the surface areas of the constituent materials based on their weight fractions. Accordingly, usage of starting materials with higher surface areas will increase the resulting surface area of the composite. Researchers have experimentally observed surface areas of 1587 m²/g (Cinke, M. et al. CHEM. PHYS. LETT. 365, 2002, 69-74) and 3190 m²/g (Wang, H. et al. J. OF AM. CHEM. SOC. 131, 2009, 7016-7022) for SWNTs and aCs, respectively.

Assuming a 1:1 weight ratio composite of these two higher surface area materials is fabricated using the method described herein, a surface area of over 2300 m²/g is predicted. Such large surface areas would be unprecedented for materials with the ability to obtain the high conductivities shown to be achievable from CNT networks. The highest combination of specific surface area and electrical conductivity which could be found in the literature was 1600 m²/g and 150 S/cm for carbide-derived carbons (see Chimola, J. et al. SCIENCE, Vol. 313, 2006, no. 313). With engineering and optimization of the CNT-aC composites, the combination of large surface area and high conductivity could surpass that of other carbon morphologies.

### Example 9

### Pore Size Distributions

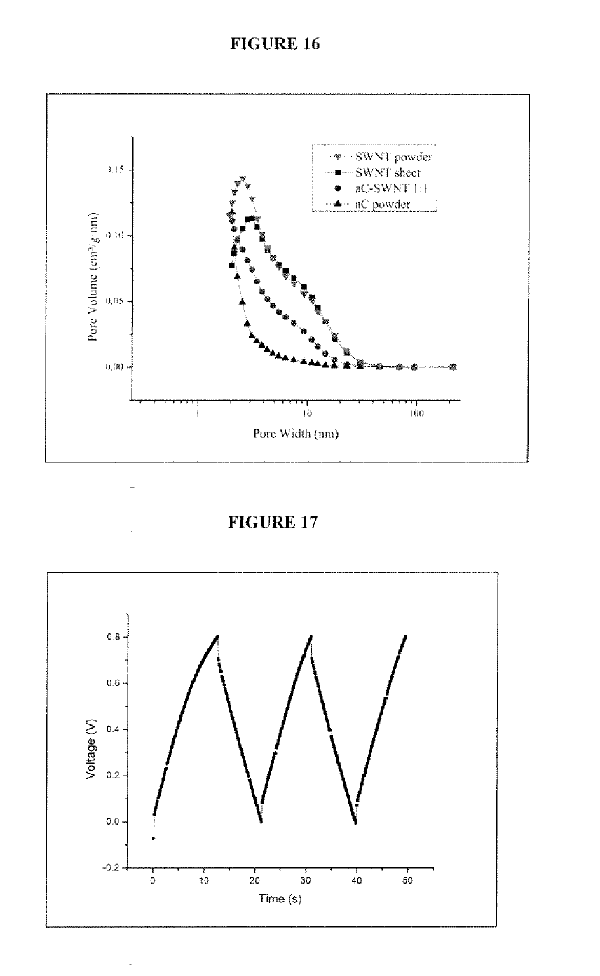

The pore size distribution (PSD) of high surface area carbons is vital to anticipate their behavior in final applications. See Beguin, F. et al. “Carbons for Electrochemical Storage and Conversion Systems,” Boca Raton: CRC Press, 2009. The PSI) comparison of the SWNT powder, pure SWNT sheet, a 1:1 aC-SWNT composite and the aC powder is shown in FIG. 16.

The 1:1 ratio composite shows an intermediate PSI) with values between that of the aC and SWNT samples. The broader distribution indicates a mesoporous structure of the composite provided by the spaces in-between CNTs. Although, unlike the SWNT samples, the peak of the distribution of the 1:1 composite is found at the smallest pore size, similar to the aC PSD. This may be an optional structure for capacitive electrodes where the mesoporous regions created by the CNT network could allow quick and easy access for the electrolyte ions to reach the entire microstructure of the material. Easily accessible, the microporous surfaces of the aC particles provide the smaller sized pores required for efficient ion adsorption.

### Example 10

### Electrochemical Characterization of aC-SWNT Electrodes

Electrochemical tests were conducted on SWNT-aC electrodes with 50 weight percent aC. Cyclic voltammetry (CV) was performed to view the response to reduction and oxidation currents of electrodes in a potassium hydroxide (KOH) aqueous electrolyte. Galvanostatic cycling was performed after the CV tests with the samples in the 3 electrode setup for 5000 cycles and on symmetric “beaker cell” electrochemical capacitors for 30,000 cycles.

The initial cycles of the constant current cycling test are shown in FIG. 17. The IR drop was initially around 0.09 V, but decreased as the tests progressed. This phenomenon of resistance decrease was also observed in electrochemical impedance spectroscopy tests performed before and after cycling. A constant current of 3.62 mA/cm² (1.12 mA/mg for the combined electrodes mass) was used.

The specific capacitance was calculated using the charge-discharge results from formula (2):

$$C = \frac{I}{( \frac{d V}{d t} ) * m} \qquad ( 2 )$$

In formula (2), C is the specific capacitance, I is the discharge current, m is the electrode mass and dV/dt was calculated as the slope of the discharge curve between 0.25-0.5 V where dV/dt was perfectly linear and the IR drop (ohmic drop) was avoided.

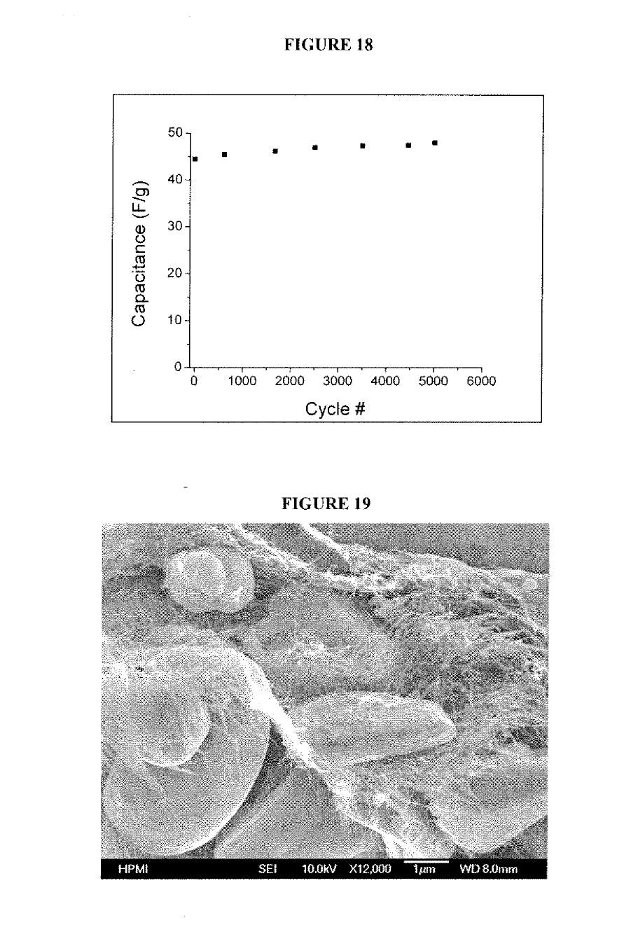

FIG. 18 shows the results for the half-cell test using a current of 10 A/g. The electrode sample showed no capacitance loss through 5000 cycles even with the high current of 10 A/g, indicating the high power capability provided by the highly conductive and robust CNT networks.

### Example 11

### Other Particles Systems Fabricated Using the Methods Described Herein

A number of other particle systems were fabricated using the methods and techniques described herein. These include composite materials containing the following: LiFePO₄:MWNT (80:20), LiFePO₄:SWNT (90:10), and LiCoO₂:MWNT (95:5). FIG. 19 is a cross-section SEM of the composite material containing LiCoO₂:MWNT (95:5).

### Example 12

### More Testing on CNT:aC Composite Materials

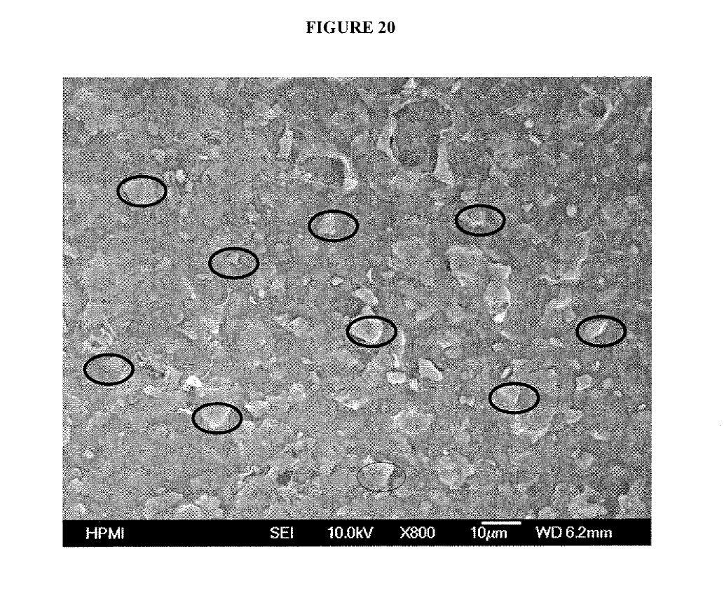

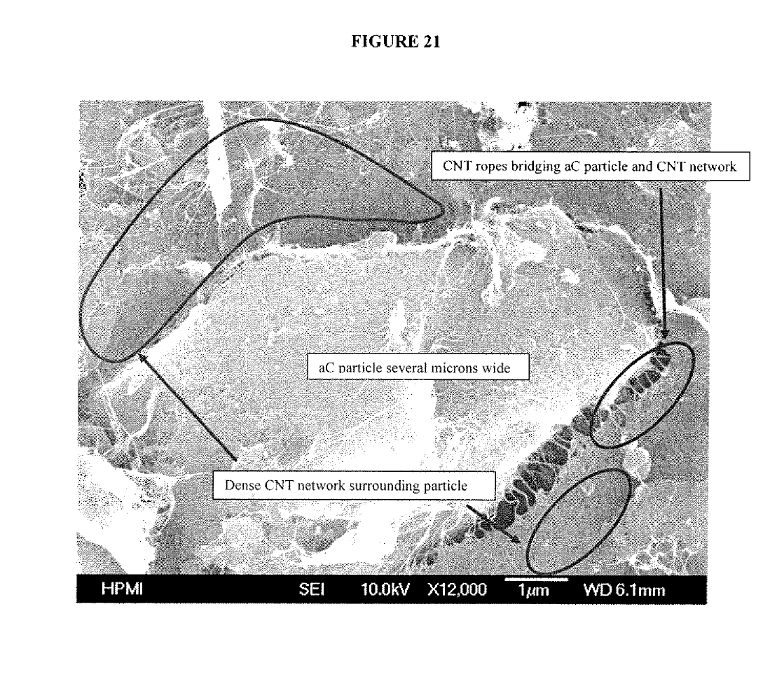

FIG. 20 is a low-magnification SEM image showing uniform dispersion of aC particles in CNT network. Several of the aC particles are circled. Similar particles can be seen uniformly disbursed throughout the entire image. Similarly, FIG. 21 is high magnification image of an aC particle partially pulling out of the CNT matrix. The larger particle is surrounded by a dense network CNT. CNT ropes can be seen on parts of the particle surface and connecting the aC particle to the bulk CNT matrix.

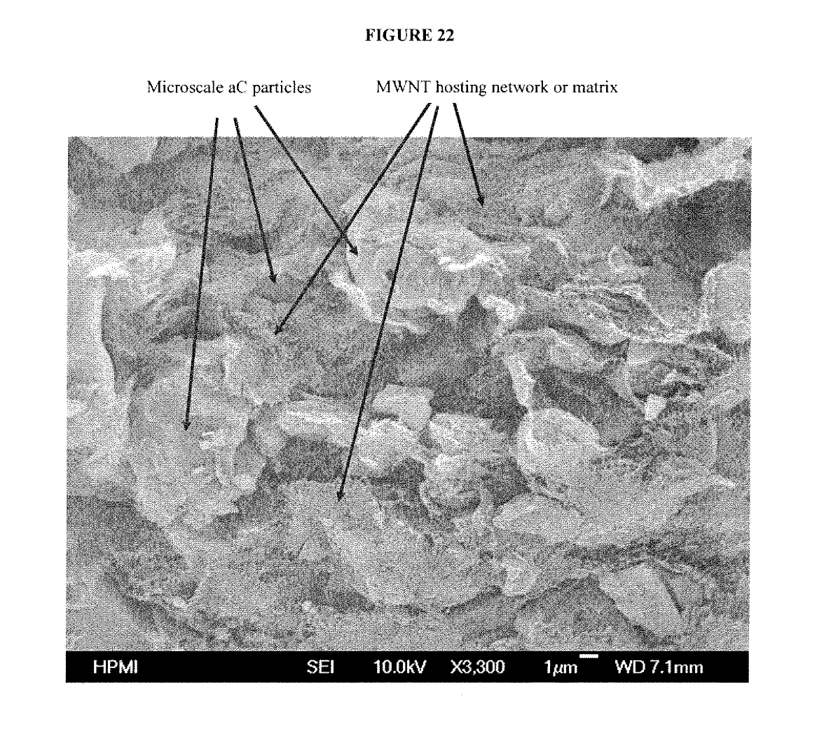

FIG. 22 is a SEM image of the of the cross-section of a 67 wt. % aC:MWNT system. The MWNT hosting network is well illustrated with activated carbon particles dispersed throughout it. The MWNTs used here were produced by CNano Technology Limited (Santa Clara, Calif.).

Modifications and variations of the methods and devices described herein will be obvious to those skilled in the art from the foregoing detailed description. Such modifications and variations are intended to come within the scope of the appended claims.

We claim:

1. A method for making a composite material comprising:
forming a first suspension comprising (i) carbon nanotubes and (ii) first particles and/or fibers of interest;
filtering the first suspension to form a sheet which comprises a network of the carbon nanotubes wherein the first particles and/or fibers of interest are embedded in the network; and
drying the sheet to form a free-standing sheet structure that is free of polymeric binder.

2. The method of claim 1, wherein the first particles are microparticles.

3. The method of claim 2, wherein the first particles range from about 1 to about 20 micrometers in size.

4. The method of claim 1, wherein the first particles comprise silicon particles.

5. The method of claim 1, wherein the first particles comprise activated carbon particles.

6. The method of claim 1, wherein the first particles comprise particles of a lithium compound.

7. The method of claim 6, wherein the first particles comprise lithium iron phosphate (LiFePO₄), lithium manganese oxide (LiMn₂O₄), lithium cobalt oxide (LiCoO₂), lithium nickel oxide (LiNiO₂), or any combination thereof.

8. The method of claim 1, wherein the first particles comprise Ge, GeAs, SnTe, InAs, CdSe, TiO₂, GaSb, InSb, SnSe, GaP, InP, AlP, AlAs, ZnTe, CdSe, CdTe, alloys thereof, or any combination thereof.

9. The method of claim 1, wherein the first particles comprise Sri, Al, Fe, Au, Ag, Pt, Ni, Ti, V, Cu, Pd, Pt, In, Co, Zn, Mn, Pb, Rh, Li, Na, alloys thereof, oxides thereof, or any combination thereof.

10. The method of claim 1, wherein the first suspension comprises an aqueous liquid.

11. The method of claim 10, wherein the aqueous liquid comprises at least one surfactant.

12. The method of claim 11, wherein the residual surfactant is at least partially removed by a process comprising washing, heat treatment, or a combination thereof.

13. The method of claim 1, wherein the carbon nanotubes comprise SWNTs, MWNTs, or a combination thereof.

14. The method of claim 1, further comprising:
forming a second suspension comprising (i) carbon nanotubes and (ii) second particles and/or fibers of interest; and
filtering the second suspension on the sheet which comprises the network of the carbon nanotubes comprising the first particles of interest.

15. A method for making a composite material comprising:
forming a first suspension comprising carbon nanotubes;
forming a second suspension comprising (i) carbon nanotubes and (ii) first particles and/or fibers of interest;
filtering either the first or second suspension; and
filtering the remaining suspension on the previously-filtered suspension to form a dual-layer, free-standing sheet structure that is free of polymeric binder.

16. The method of claim 15, wherein the first particles are microparticles.

17. The method of claim 15, wherein the carbon nanotubes are SWNTs, MWNTs, or a combination thereof.

18. The method of claim 15, wherein the method further comprises:
forming a third suspension comprising carbon nanotubes; and
filtering the third suspension on the dual-layer, free-standing sheet structure to create a multi-layer, free-standing sheet structure that is free of polymeric binder.

19. A composite sheet material comprising:
a network of carbon nanotubes; and
at least one type of particles embedded in the network, wherein the network is a free-standing structure free of polymeric binder.

20. The composite sheet material of claim 19, wherein the particles are microparticles.

21. The composite sheet material of claim 19, wherein the particles comprise silicon particles, activated carbon particles, particles of a lithium compound, or any combination thereof.

22. The composite sheet material of claim 19, wherein the first particles comprise lithium iron phosphate (LiFePO₄), lithium manganese oxide (LiMn₂O₄), lithium cobalt oxide (LiCoO₂), lithium nickel oxide (LiNiO₂), a metal, semiconductor, alloy, oxide, or any combination thereof.

23. The composite sheet material of claim 19, wherein the carbon nanotubes are SWNTs, MWNTs, or a combination thereof.

24. The composite sheet material of claim 19, wherein the weight percentage of particles in the composite sheet material ranges from about 5 to about 99 percent.

25. The composite sheet material of claim 19, wherein the thickness of the composite sheet material ranges from about 10 μm to about 500 μm.

26. The composite sheet material of claim 19, wherein the carbon nanotubes have an average diameter of less than about 20 nm, and an average length of greater than about 1 micron.

27. The composite sheet material of claim 19, wherein the composite sheet material is arranged between two carbon nanotube sheets.

28. A lithium-ion cell or battery comprising a composite sheet material according to claim 19.

29. A composite sheet material comprising:
a network of carbon nanotubes; and
fibers of interest embedded in the network, wherein the network is an free-standing structure free of polymeric binder.

30. The composite sheet material of claim 29, wherein the fibers of interest comprise carbon fibers, silicon fibers, semiconductor fiber, or metal fibers.
